(19) United States
(12) Patent Application Publication
(10) Pub. No.: US 2014/0200075 A1
(43) Pub. Date: Jul. 17, 2014

(54) PERSONALIZED PLAY WITH REWARDS FOR GAMES OF CHANCE

(71) Applicant: Kevin D. Krietemeyer, Las Vegas, NV (US)

(72) Inventor: Kevin D. Krietemeyer, Las Vegas, NV (US)

(21) Appl. No.: 14/016,159

(22) Filed: Sep. 2, 2013

Related U.S. Application Data
(63) Continuation-in-part of application No. 13/229,659, filed on Sep. 9, 2011, now Pat. No. 8,523,669.
(60) Provisional application No. 61/381,198, filed on Sep. 9, 2010.

(51) Int. Cl. G07F 17/32

(52) U.S. Cl. CPC G07F 17/3241
USPC 463/29

(57) ABSTRACT

A personal play system and process are used provide alternative prize structures to lottery players at random or based on player characteristics. An authorized player accesses their user account in the system and creates a personalized game document. The personalized game document is scanned by a retail terminal's electronic scanner. The information is communicated to the lottery system's host computer which logs the information and verifies that the transaction can be completed by printing a personalized lottery ticket at the retailer terminal. Alternative prize structures can be selected from single price point game prizes or multiple price point game prizes and can be optionally presented to the players for their selection according to various criteria, including loyalty-level rewards or other unlock criteria based on a player identifiable information, as well as up-sell options, suggestive-sell options, and mystery prizes. Also, bonus number play and SurePlay options may be selected.

### CROSS-REFERENCE TO RELATED APPLICATIONS

This application is a continuation-in-part of U.S. patent application Ser. No. 13/229,659 filed on Sep. 9, 2011, which claims priority from U.S. Provisional Patent Application No. 61/381,198 filed on Sep. 9, 2010.

### STATEMENT REGARDING FEDERALLY SPONSORED RESEARCH

Not Applicable.

### APPENDIX

Not Applicable.

### BACKGROUND OF THE INVENTION

1. Field of the Invention

This invention relates generally to lottery systems and more particularly to identifying the individual or group that has purchased a lottery ticket.

2. RELATED ART

Since the advent of the online lottery industry, the lottery game tickets have been anonymous, bearer instruments. This has implications for players and lotteries, where players risk the potential for retailer fraud and the loss of a ticket equates to a loss of rights. Also, lotteries have very limited data on the players.

Of these concerns, limiting the potential for retailer fraud has become paramount in recent years due to concerns raised primarily in Canada. As a response to this, lotteries have expanded distribution of check-a-ticket technology that provides players an opportunity to scan a game ticket prior to giving the game ticket to their retailer for validation. However, this technology is expensive and occasionally causes the player as many headaches as it resolves, due to messaging on the device and the consistency of read rates.

In most lottery games, the game ticket is a bearer instrument in which a loss of a winning ticket results in a loss of rights to the winnings. Accordingly, it becomes incumbent upon the player to retain their game ticket and ensure that their retailer validates their game ticket. Failure on the part of the player to take either of these actions results in a negative experience for the player, from what should be a positive one.

Also, as bearer instruments in most lottery games, game tickets provide very little player information. Play data is limited to the parameters supported either by the play-slip or via the terminal. As a result lotteries are limited to a combination of player club membership/2nd chance drawings, and claim files to ascertain any specific level of a player's preferences. As competing industries are finding creative ways to leverage technology to develop a more personal relationship with their customers, it has become critically important that lotteries pursue this goal as well.

Currently, most host lottery systems are designed in accordance with the needs of an anonymous player, and all lottery systems that operate by scanning play-slips at retail terminals follow the anonymous player model. Accordingly, systems' promotion modules limit administrators to define only narrow set of criteria by which promotions will be offered, such as promotions based on Every Nth Ticket, Buy X Tickets, and Time/Date (i.e. from 5 PM-7 PM on Fridays). For anonymous players, these criteria are paired with promotions that provide free plays, higher payouts, and entries. Such promotions can be offered system-wide. The only choice players have is whether or not they want to purchase the qualifying transaction.

### SUMMARY OF THE INVENTION

The present invention is a platform that allows players the opportunity to personalize their lottery game ticket. Appending player information to a lottery transaction addresses a significant, ongoing challenge for lotteries, eliminating retailer fraud.

The present invention provides alternative prize structures to players at random, based on player characteristics such as current/previous purchases and other “loyalty” indicators.

The present invention utilizes features such as upsells, suggestive sells, mystery prizes, etc. to increase player involvement and player wager amounts.

Once player information is included with the ticket purchase, a Lottery receives more specific information about their players' preferences. This provides unique marketing opportunities for the Lottery to create a more personal playing experience.

Additionally, the present invention utilizes a barcode for generating transactions which simplifies ticket processing for retailers, and, since bar code scanners require no moving parts, also reduces terminal wear for a technology provider.

Finally, with the present invention, the player-generated scanning-code (such as a barcode) will replace the play-slip, allowing a technology provider to experience a reduction in consumables expense.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a system block diagram of the components used in the present invention.

FIG. 1B is a flow chart of the overall process.

FIG. 2 is a section from a webpage providing game options.

FIG. 3 is a login screen.

FIG. 4 is a screenshot of game options and play criteria options.

FIG. 5 is a view of a personalized game document according to the present invention.

FIG. 6 is a view of a personalized lottery ticket according to the present invention.

FIG. 7 is a view of a validation receipt for a winning ticket with personal player information.

FIG. 8A is a chart of a currently available prize structure.

FIG. 8B is a chart of a graduated prize structure according to the present invention.

FIG. 8C is a chart of alternative prize options according to the present invention.

FIG. 8D is a matrix of various alternative prizes according to the present invention.

FIG. 9 is a play-slip with a game playing field and a player identification field.

FIG. 10 is a flowchart illustrating an unlock feature for alternative prize structures.

FIG. 11 is a flowchart illustrating an up-sell feature for alternative prize structures.

FIG. 12 is a flowchart illustrating a suggestive sell feature for alternative prize structures.

FIG. 13A is a flowchart illustrating a randomly-presented mystery prize feature for alternative prize structures.

FIG. 13B is a flowchart illustrating a player loyalty-based mystery prize feature for alternative prize structures.

FIG. 13C is a flowchart illustrating mystery prize up-sell feature for alternative prize structures.

FIG. 14 is a flowchart illustrating a bonus number feature for alternative prize structures.

FIG. 15A is a flowchart illustrating a fixed-odds game SurePlay feature for alternative prize structures.

FIG. 15b is a flowchart illustrating a pari-mutuel game SurePlay feature for alternative prize structures.

### DETAILED DESCRIPTION OF THE PREFERRED EMBODIMENTS

The following description of the preferred embodiment(s) is merely exemplary in nature and is in no way intended to limit the invention, its application, or uses.

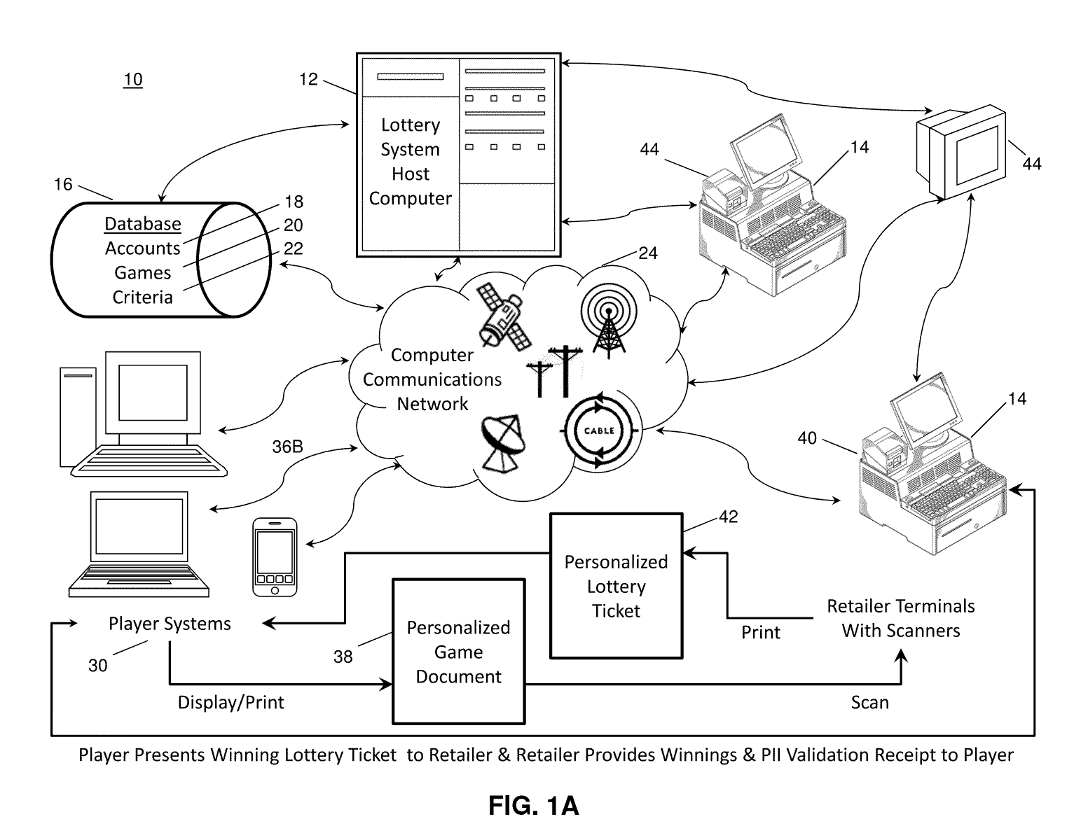

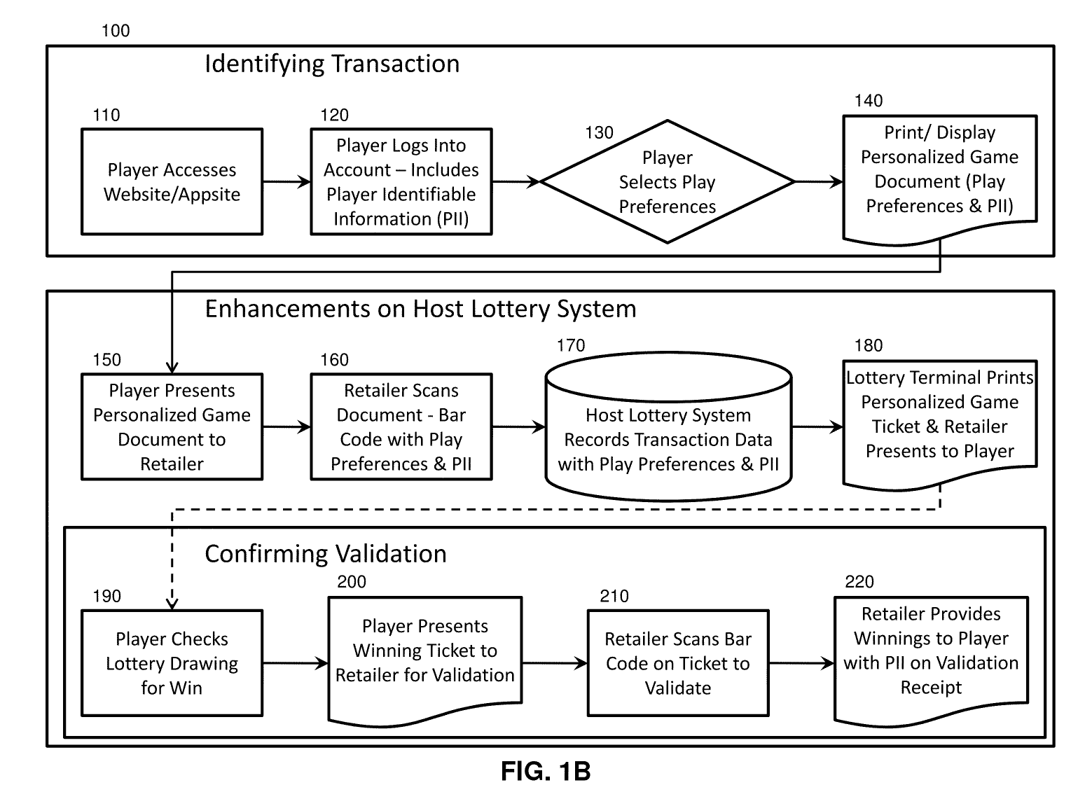

The overall system 10 and process 100 of the present invention are described with reference to FIGS. 1A and 1B. Each of the steps in the process are particularly described with reference to additional illustrations to further explain the invention as set forth in the claims. Generally, the system and process establish ownership of a lottery game ticket and provide additional security and game options for lottery players and are referred to throughout this specification as the personal play system and process 10, 100.

A host computer 12 for the lottery system is in operative communication with a plurality of retailer terminals 14. An electronic database 16 contains player accounts 18, game options 20 and play criteria options 22 that are securely accessible through a computer communications network 24. The player accounts include player identifiable information (PII) 26, such as a player's name, and may also include a user ID or other player identification code 28. The players access their accounts on the database 16 as authorized players on their computer systems 30 via the computer network 24. The game options 32 and play criteria options 34 are defined according to the lottery system's rules of play. As discussed in detail below, the rules of play for the lottery system can be expanded to include additional options for authorized players with accounts managed within the database.

It will be appreciated that any type of computer communications network could be used to provide the users with access to their accounts, including computers that access the database through a webpage interface and smartphones that access the database through a specialty phone application. In either case, it is preferable to have a graphical interface 36A which has a communication link 36B to the system 10. The host computer may be in direct communication with the database which may be integrated within the lottery system's server or computer system.

As explained in detail below, the process to establish ownership of the lottery game ticket begins with an authorized player accessing their user account 18 in the personal play system 10 and creating a personalized game document 38 which contains both play data and player identifiable information (PII). The personalized game document 38 can be scanned by an electronic scanner 40 of a retailer terminal 14, where the information is communicated to the lottery system's host computer 12. The lottery system host computer 12 which then logs the information and verifies that the transaction can be completed by the retailer terminal printing a personalized lottery ticket 42. While the above example describes the personalized game document as a physical document, it will be appreciated that the personalized game document can be used by the host computer 12 as an electronic order.

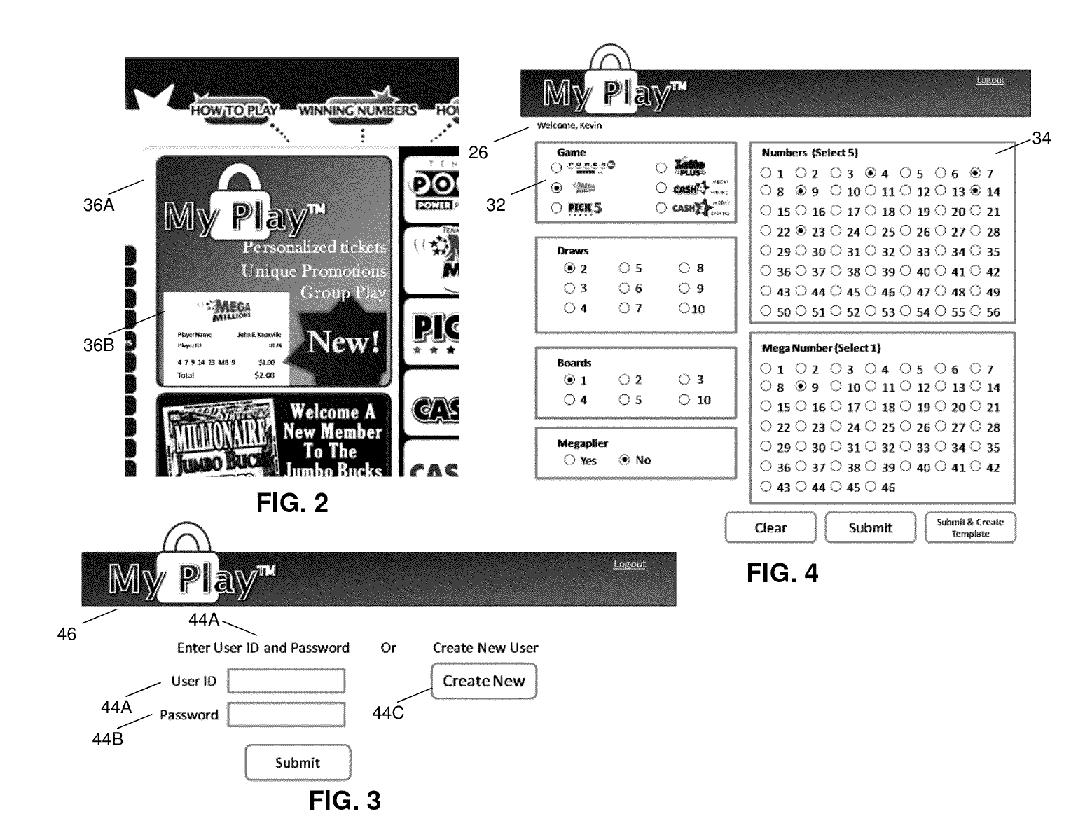

A player can access their user account through a link to the personal play system. The link may be presented to players on the home page of a lottery's web site or it may be an application button on a smart phone. An example of a graphical interface 36 is shown in FIG. 2. Accordingly, it will be appreciated that the communication link to the system can be through a web interface, a smart phone application interface, a tablet application interface, a lottery kiosk, or some combination thereof. It will also be appreciated that the communication link to the system can be through a point-of-sale (POS) terminal 44 at the retailer. The POS terminal 44 can be a part of the retailer terminal 14 or it may be a stand-alone unit that is operatively connected to the retailer terminal 14, the lottery system's host computer 12, or both.

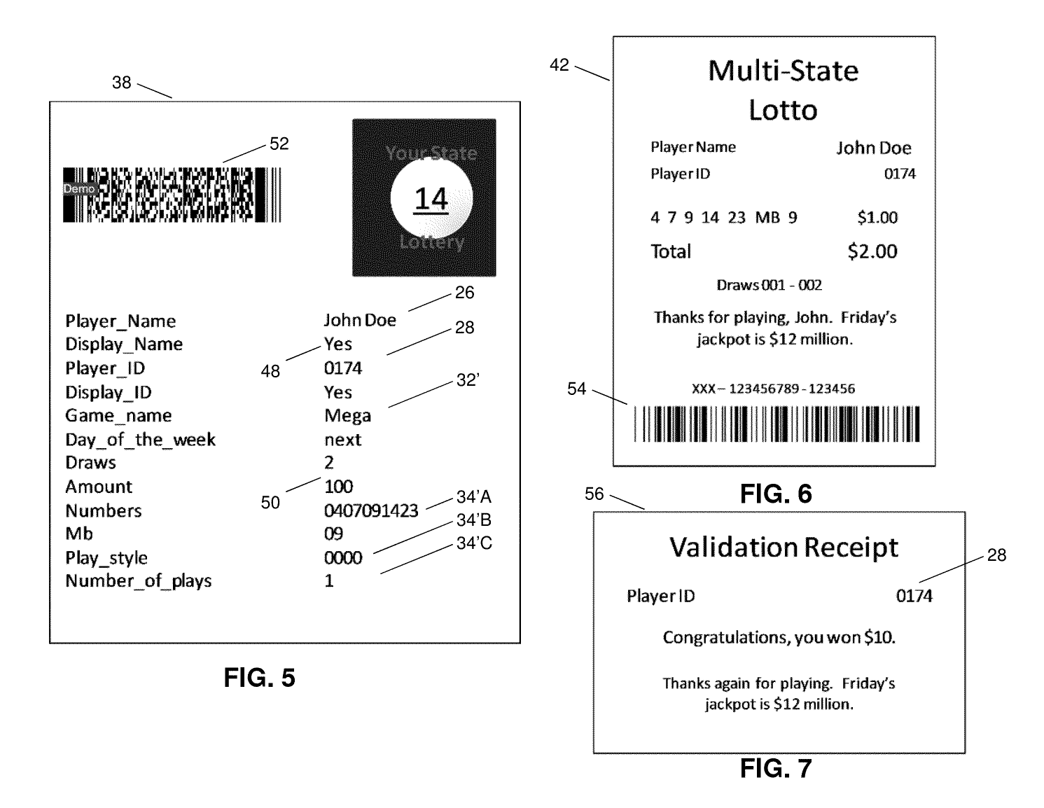

The player accesses the personal play system through the communication link 110 and is prompted to enter login information 44, such as a user ID 44A and password 44B, on a login screen 46 as shown in FIG. 3. The player will either do so or, in the case of a player that has not utilized the personal play system service before, create a new user account 44C. As indicated above, the user accounts contain the player identifiable information (PII) and may include player preferences. For example, as shown in FIG. 5, one player preference could be a display-name option 48 in which the player can choose whether their name should be displayed on the personalized game document and the personalized lottery ticket or whether only the player ID should be shown. Once the player is signed in, they can begin the process of creating their personalized game document which can result in a personalized lottery ticket when the transaction is verified by the lottery system. Accordingly, in this manner, a player is authorized to securely access one of the player accounts in the electronic database through the computer communications network 120.

As indicated in the play preferences selection step 130 in FIG. 1B and shown in FIG. 4, when the player logs into their personal play system account, the site acknowledges the player by name 26 and presents the player with a set of game options 32. The player selects the game they would like to play, and the personal play system presents other play criteria 34 for which it needs player input. The player submits their selections for the play data 32′, 34′ once they have indicated their preferences, and the personal play system receives the play data from the authorized player through the computer communications network.

The personal play system uses the player's personal information 26, 28 and selected play data 32′, 34′ to create the unique personalized game document for the player. As shown in FIG. 5, the play data includes the game selection 32′, the play criteria selections 34′ and wager details 50. The game selection preferences may include numbers 34′A, play style 34′B, and number of plays 34′C such as shown for the selected game 32′ (Mega, i.e., Mega Millions). The personal play system also generates a unique scanning-code 52 which defines all of the PII and the selected options for the particular play. The scanning-code can be a bar code or another type of scannable code, such as a data matrix, which is recognized by the electronic scanners at the retailer terminals. The personal play system creates the personalized game document with the PII, the play data and the scanning code. The player can print or otherwise display the personalized game document that is created by the personalized game system 140.

It will be appreciated that in many cases, the personalized game document would be printed by the authorized player and then brought to the participating retailer to be scanned. It will also be appreciated that the personalized game document can be maintained in its electronic form and either the display image can be scanned into the retailer terminal or the information could be transmitted directly into the retailer terminal, such as through a wireless connection. This would be most effective with a smart phone application although it is expected that tablet computers could also be used for this option. In either event, the personal play system transmits an electronic version of the personalized game document to the authorized player through the computer communications network.

The personal play system instructs the authorized player to present the personalized game document 38 to a participating retailer in order to process the unique data with the host lottery's computer system 12. The participating retailer is instructed to scan said personalized game document using the electronic scanners and to provide the authorized player with the personalized lottery ticket 42 which corresponds with the unique data on the personalized game document as it is interpreted by the host lottery's computer system. Accordingly, the player takes the personalized game document to the participating retailer for scanning at the lottery terminal 150. The terminal processes the information contained in the scanning-code and sends the corresponding data to the host lottery system 160. Since the player's personal information is included in the scanning-code, the scan provides this information to the host lottery system, and the host logs the play data along with the player's personal information and then sends a reply to the lottery terminal 170. Software programming for both the lottery terminal and the lottery's host system will interpret the data presented in the bar code, and the host system can store the additional data that can now be appended to a player's transaction. The personal play system logs the player identifiable information and the play data for the authorized player at the host lottery system as a recorded transaction.

The host system sends a verification report to the participating retailer's terminal to authorize the printing of the personalized lottery ticket for the recorded transaction. As indicated above, personalized lottery ticket includes the player identifiable information (or just the player code if desired) along with the play data corresponding with the unique data on the personalized game document. Once the participating retailer's terminal receives verification that the host has recorded the transaction, the terminal prints the personalized lottery ticket such as the one shown in FIG. 6 and the retailer presents the ticket to the player 180. Since the unique information is logged and stored on the lottery system, the personalized lottery ticket could be printed with a unique serial number 54 that corresponds with the stored information.

Following the drawing, the player checks the numbers on their personalized lottery ticket to determine whether or not they have won 190. For a winning ticket, the player returns to the retailer to validate their ticket 200. The retailer scans the game ticket's code, and the host system validates that the serial number represents a winning ticket 210. In general, the host lottery system can receive any information that corresponds to a winning personalized lottery ticket. This information can be the unique serial number or it may be the same player identifiable information and play data that was on the personalized game document. The host lottery system authorizes the participating retailer to pay a winning amount with a validation receipt 56 which confirms the player identifiable information 220. An example of a validation receipt is shown in FIG. 7.

As indicated above, the retailer is authorized to pay the amount won to the player with the validation of the ticket by the host system. By having the retailer provide the player with the validation receipt, the lottery system confirms for the player that the ticket scanned was the player's ticket which gives the player a new level of fraud protection that anonymous lottery tickets cannot replicate.

The player has the ability to determine which of their personal information is available for presentation on both their ticket and their validation receipts. These determinants will be established when the player establishes their player profile through the web interface. In addition to their name, players will have the ability to specify a User ID. This alternative is offered to provide a code that the player will be able to quickly associate with their ticket or validation receipts. A code also offers a means of identification while maintaining the player's privacy. For the validation receipt shown in FIG. 7, the player selected the option in which the player ID 28 is displayed so the player's name does not appear.

There have been four major movements in the modern history of lotteries. Each of these movements has served as a building block for new products or services. The four generations are summarized below.

Generation 1: Passive Games/Instant tickets (1964-Present)

Generation 2: Online Systems/Draw Games/Lotto (Late 1970's-Present)

Generation 3: Enhanced Frequency/Social Games & VLTs (Late 1980's-Present)

Generation 4: Player-Centricity/Player Clubs (2000's-Present)

The industry is currently in the midst of migrating to a more player-centric experience. To date, this movement has been initiated by the emergence of player clubs, but the ultimate manifestation will be interactive gaming. While the legal status of interactive gaming for lotteries continues to be debated, there are certain opportunities available with the present invention that will allow a lottery to provide its players a more personal experience beyond that of the personalized ticket/validation receipt.

Personalizing the play experience through the present invention produces a number of marketing opportunities, including administration of group play, personalized prize structures—graduated prize structures, payout promotions for fixed prize games, time/draw sensitive promotions, cross-marketing promotions with other games, and eligibility for promotional drawings. Of these marketing opportunities, a few uniquely address issues never before addressed by the lottery industry.

The personalized play of the present invention permits the administration of group play. For high jackpot, lotto style games, players occasionally pool their wagers with other players to improve their odds of winning. These groups or syndicates are established with the understanding that winnings will either be split evenly or on a pro-rated basis in accordance with the amount each member contributes.

Some lotteries allow groups to register, but typically the groups are rather informally administered which result in a controversy for the lottery. When one of these groups wins, invariably a player that has participated with the group in the past claims, rightly or wrongly, that they were a member of the group for the drawing won. Generally this results in a lawsuit that in certain cases includes the selling lottery.

The present invention creates a platform from which group play can be administered. Since the transaction is identified, one of the data elements included in the bar code can be the group's name. Members of the group will be administered by the personal play system through the web site. For each week, only present members of the group will be logged as participating with the group.

The personalized play of the present invention also allows for personalized prize structures. In concert with the present invention (or other method for identifying a player), players could further personalize their lottery experience. The player's account could have a number of parameters. Included within those parameters could be prize structures for games. With current systems designed around an anonymous player, prize structures must be standardized. For example, a lottery might currently have a prize structure for a 3 digit, Keno wager as shown in the table below.

| Match | Standard Prize |
|---|---|
| 3 | $27 |
| 2 | $2 |
| 1 | $0 |
| 0 | $0 |

A uniquely identified player enables the ability to allow the player to choose or create a unique prize structure. Perhaps the player would prefer one of the optional prize structures shown in the table below instead of the standard prize structure above:

| Match | Prize Opt1 | Prize Opt 2 | Prize Opt 3 |
|---|---|---|---|
| 3 | $17 | $37 | $47 |
| 2 | $3 | $1 | $0 |
| 1 | $0 | $0 | $0 |
| 0 | $0 | $0 | $0 |

Each of the prize structures shown in the tables above, including the standard prize and the optional prizes, provides the same payout percentage (65.21%) while providing the player the ability to choose how that percentage is distributed amongst the various winning outcomes.

As a compliment to personalized prize structures, the present invention could also serve as a platform for graduated prize structures. A limitation of current lottery systems is that prizes are awarded as shares. For fixed-prize games that offer multiple-denomination wager options like Daily Numbers or Keno, this means that prizes will have a direct correlation to the amount wagered. Said differently, a fixed-prize game designed to pay 50% will pay 50% regardless of the amount wagered.

For years, lotteries' portfolios of instant tickets have included multiple price point games that feature higher payouts as the price point increases. Over time, instant tickets have become a significantly greater proportion of lotteries' sales in large part due to this value dynamic. Generally, this practice has increased overall return to state governments, despite a decrease in margins. For many lotteries, this practice has been fully optimized within the instant ticket portfolio. As a result, further increases to payout percentage for instant tickets could be deleterious to overall return.

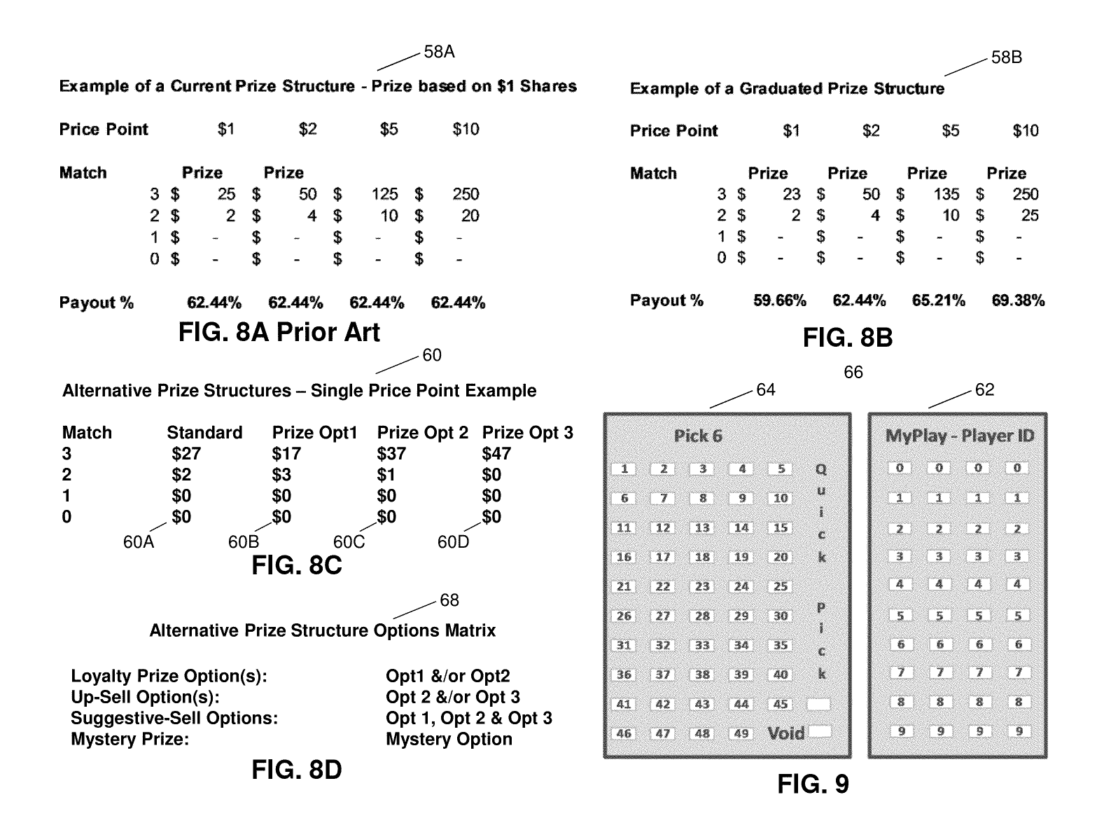

Fixed-prize, draw-based games provide a new opportunity to improve the value of the lottery experience. Draw-based games typically provide lower payout relative to instant tickets, so driving participation to these games through graduated prizes will assist in generating more return for the state. A comparison of a current prize structure of a fixed-prize, draw-based game 58A and a graduated prize structure 58B for the same game are provided in FIGS. 8A and 8B, respectively. FIG. 8C is based on the example provided above for the unique prize structures and illustrates how games with a single price point prize structure 60 can present players with the standard prize 60A also allow players to alternatively select from various non-standard prize options 60B, 60C, 60D.

Also, as explained in detail below, the system can provide alternative prize structures that may be optionally presented to the players for their selection according to various criteria, including loyalty-level rewards or other unlock criteria based on a player identifiable information, as well as up-sell options, suggestive-sell options, and mystery prizes. It will be appreciated that different alternative prize structures can be offered depending on whether the games are multiple price point game prizes 58 or single price point game prizes 60. A matrix 68 of various alternative prize options is shown in FIG. 8D, and it should be appreciated that although this matrix is provided for the example of some single price point games 60, many other prize options can be used and the alternative prize structure options are equally applicable to multiple price point games 58. According to the present invention, just as there can be multiple non-standard alternative prize options for single price point games 60, there can be multiple non-standard alternative prize options for multiple price point games 58. Also, as explained below, the player identifiable information and game selections can also be used to provide bonus number play options and a unique SurePlay option. Accordingly, the current invention could serve as a platform for allowing not only personalized prize structures from the perspective of amount paid per outcome, but also in terms of payout percentage by price point for fixed-prize, draw-based games.

The other promotions referenced become unique when coupled with an identified ticket. As mentioned previously, systems are currently limited to establish qualifying determinants system-wide. With a personalized lottery ticket, promotions can become personalized as well.

With respect to the personalized prize structure and the graduated prize structure described above, the personal play system may optionally employ an unlock feature for selectively offering an alternative prize structures to the player. The alternate prize structures may also include, but are not limited to, money, merchandise, entry into a drawing, or loyalty points offers. The personal play system does not, by default, make alternative prize structures available to all users, but instead selectively presents the alternative prize structures and/or the features described herein to the player on a random basis, based on player characteristics, or some combination thereof. For example, the personal play system selectively presents offers to a player based on characteristics including, but not limited to, the player's historical play or loyalty tier, the purchase amount for the current/most recent transaction, the version of the game being played (e.g., Keno), in exchange for loyalty points in points redemption process. The loyalty points may include points awarded to the player by the lottery operator or by a 3rd party points provider, e.g., a credit card-based points program.

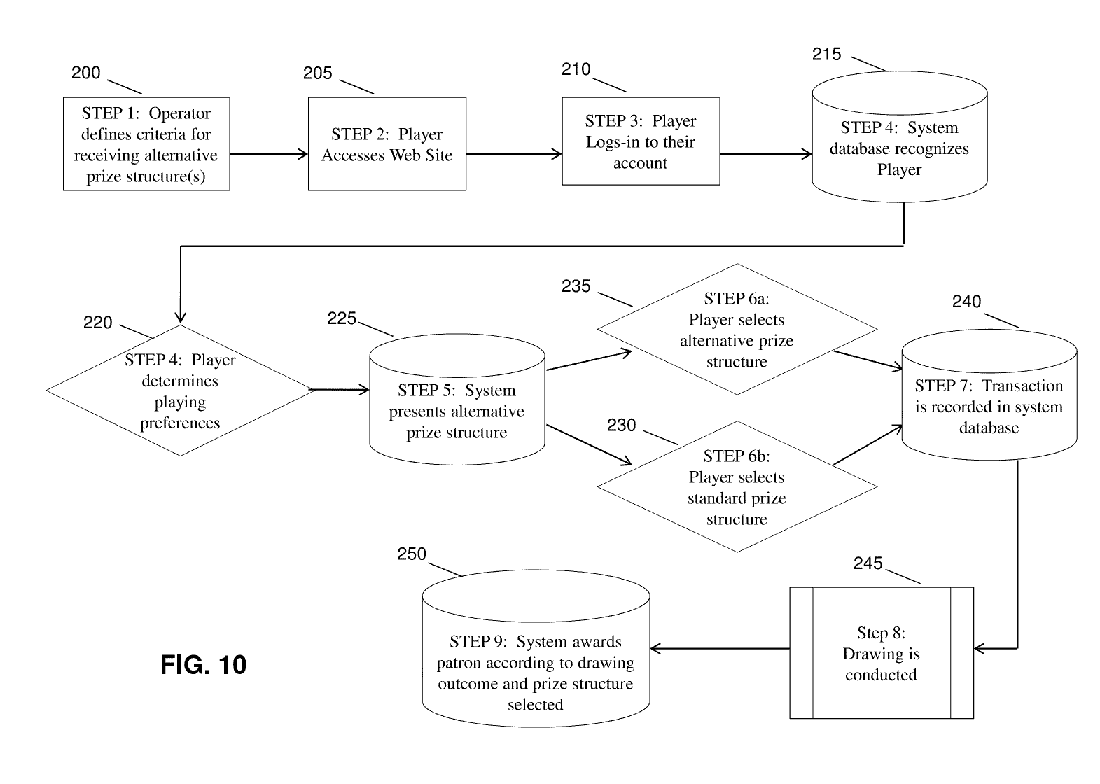

The flowchart in FIG. 10 illustrates an unlock feature process. An operator of the personal play system defines the criteria 22 the personal play system uses to selectively present the player with the alternative prize structures 200. The system may include a player loyalty engine for receiving the criteria 22 from the operator and/or the database 16, analyzing the criteria with respect to player characteristics, and selectively presenting one or more offers to players. One of ordinary skill in the art will recognize that the player loyalty engine necessarily includes other functions and operations to executing and maintaining a personal play system. Those functions and operations are within the scope of the present invention.

The player then accesses the system via the web interface 205 and logs into their account 210. Once the personal play system recognizes the player 215, e.g., the player's login information is validated against the player database 16, the web interface prompts the player to select their playing preferences 220. The system displays the standard prize structure and selectively displays the alternative prize structure(s) to the player 225 for player selection, based on player characteristics, random chance, or both. The player's selection of either the standard prize structure 230 or the alternative prize structure 235 is then recorded in the personal play system database 240. The system may also be configured to allow the player to select both prize structures (not shown). A lottery drawing is conducted 245, after which the system awards the player according to the drawing outcome and the prize structure selected by the player 250.

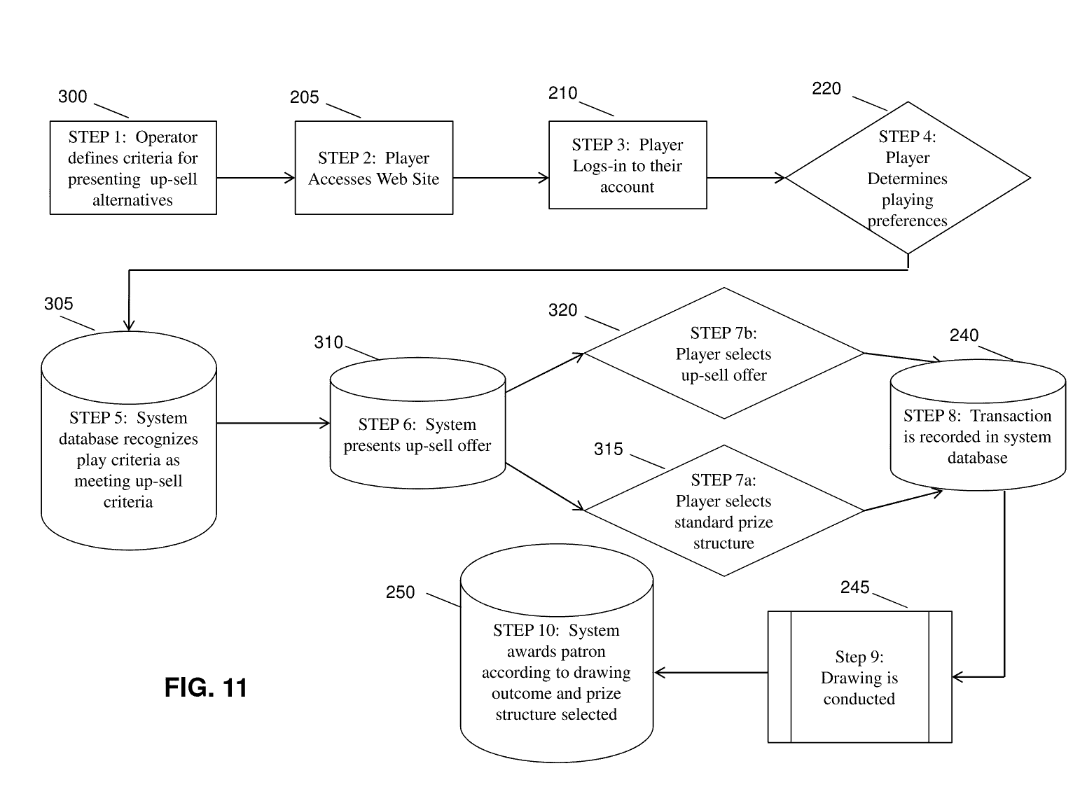

The personal play system may additionally employ an up-sell feature to, among other things, increase the purchase price of the wager. FIG. 11 illustrates an example of an up-sell feature. Similar to the unlock feature previously described, an operator defines the criteria 22 for presenting up-sell alternatives to players 300. The player again accesses the web site 205 and logs into their account 210. The web interface then prompts the player to select their playing preferences 220. The system recognizes the player's selected playing preferences as matching the up-sell criteria 305 and selectively displays the up-sell offer to the player 310. The player selects either the standard prize structure 315 or the presented up-sell offer 320, and At 240, the personal play system records the transaction in the database 16. A drawing is then conducted 245 and the personal play system awards the player according to the drawing outcome and the prize structure selected 250.

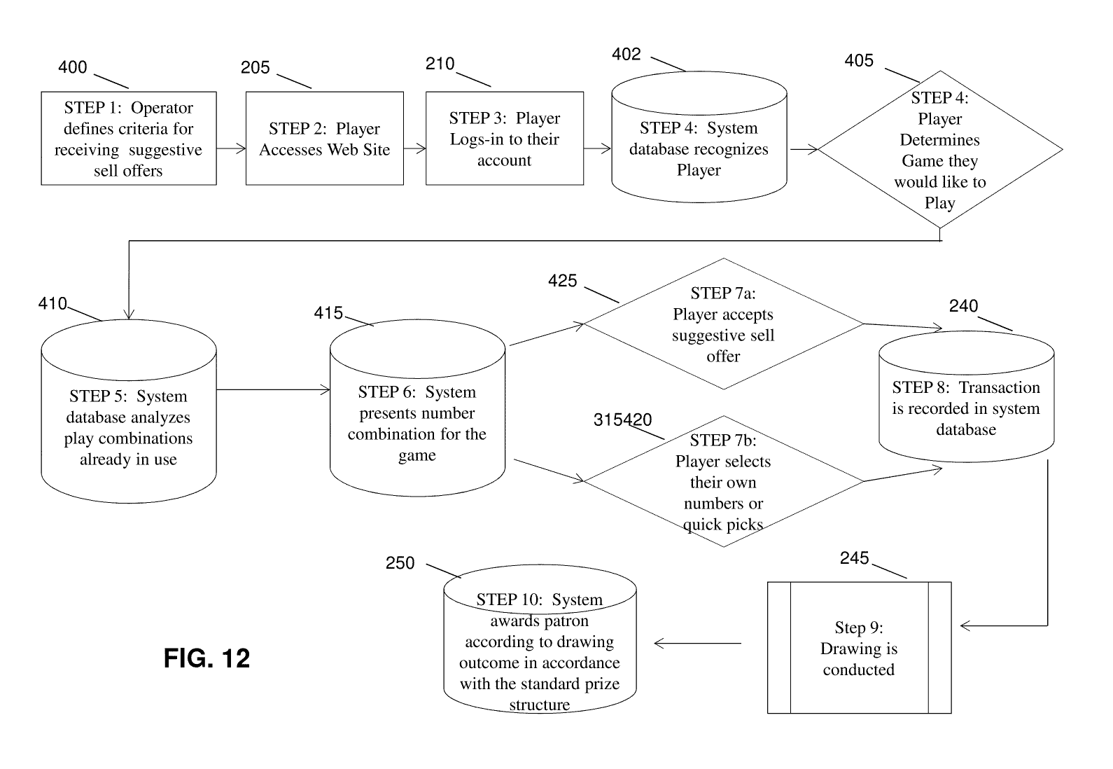

The personal play system may also employ a suggestive-sell feature for selectively offering play combinations at either a premium or at a discount. The flowchart in FIG. 12 illustrates this feature. Similar to the features described above, an operator defines the criteria 22 for presenting suggestive-sell offers to players 400. The player again accesses the web site 205 and logs into their account 210. Once the personal play system recognizes the player 402, the web interface then prompts the player to select the games they would like to play 405. The system analyzes the play combinations already in use, as reflected in the system database 410, to determine the appropriate suggestive-sell offers for the logged-in player. The suggestive-sell offers may include, but are not limited to, one or more number combinations for the player's selected game, one or more different games to play, or both. The system selectively displays the determined suggestive-sell offers to the player 415. The player then selects their own numbers or quick picks 420 or one or more of the suggestive-sell offers presented by the system 425. Based on the configuration of the personal play system, the player may also be permitted to select both. At 240, the personal play system records the transaction in the database 16. A drawing is then conducted 245 and the personal play system awards the player according to the drawing outcome and the prize structure selected 250.

The suggestive-sell feature advantageously permits a lottery operator to distribute their liability. For example, a number combination of 6-9-2 may not be a popular as combinations like 1-2-3, 3-2-1, or 3-3-3. As a result, many lottery operators establish game liability limits to protect themselves against an “unfavorable” outcome, e.g., the Pick 3 lottery drawing results in the winning numbers of 1-2-3. The suggestive sell feature allows a lottery operator to offer certain combinations, such as 6-9-2, to a player prior to purchase. With respect to a “numbers” game like Pick 3, the suggested number combination may be offered to the player at a discounted price. Additionally, the suggestive-sell feature may offer multiple combinations as a “bundle” at a discounted price.

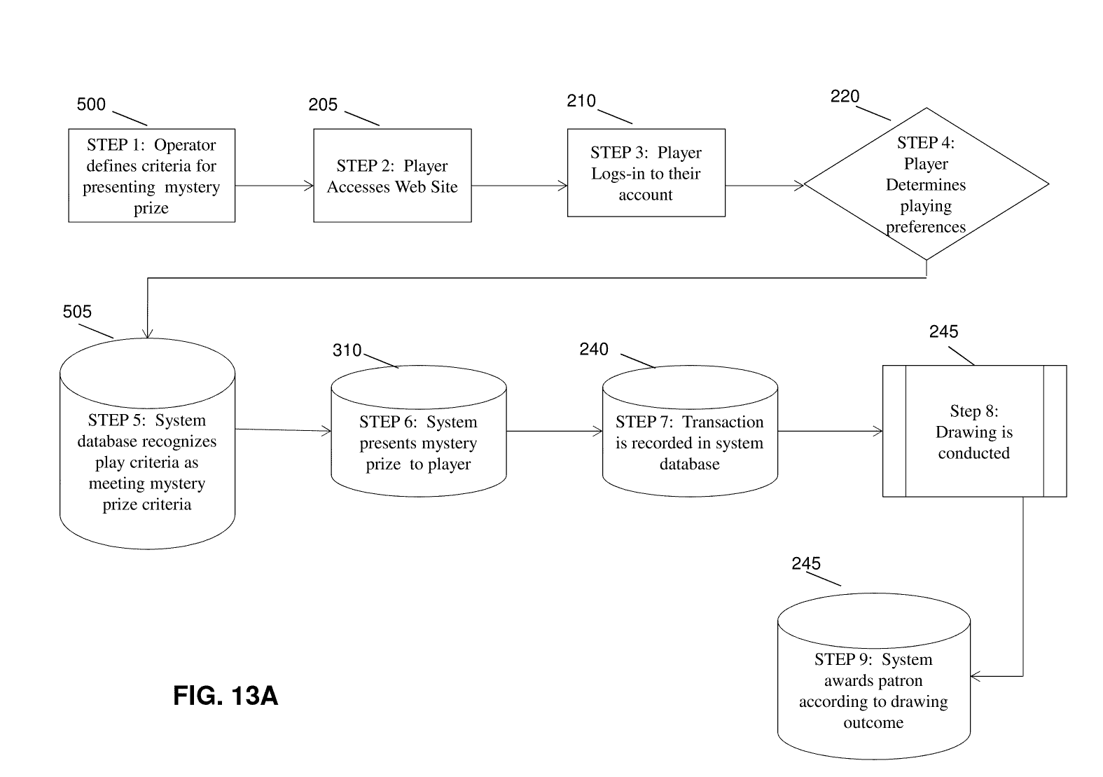

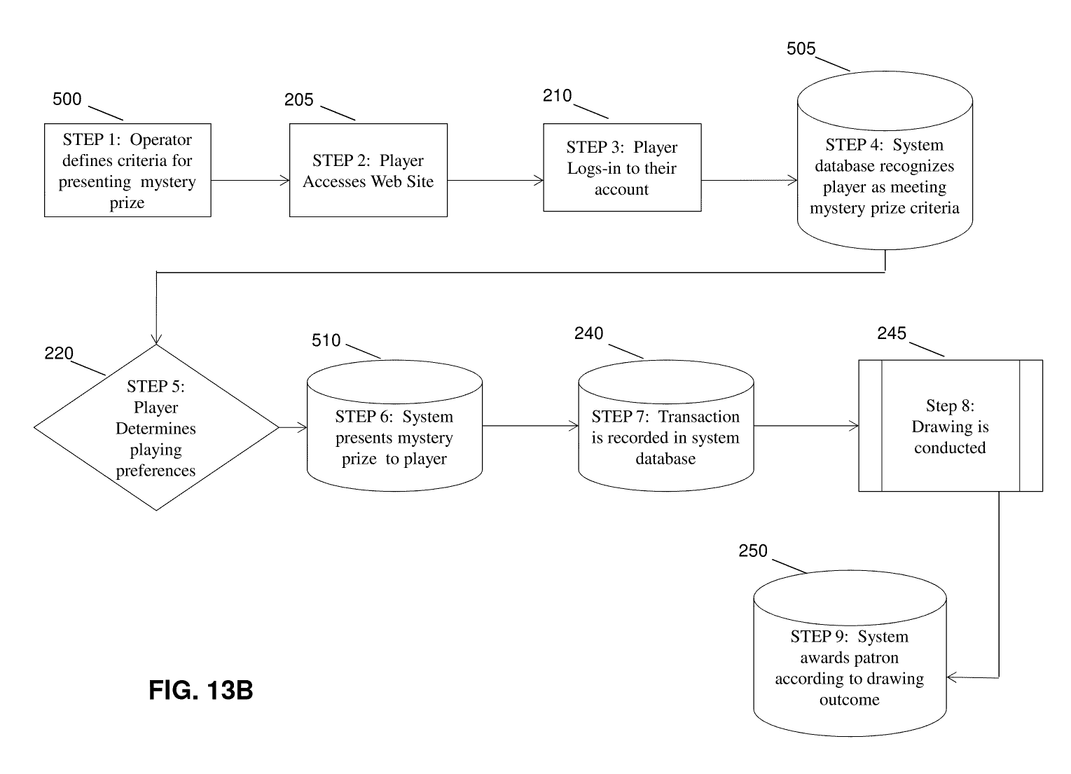

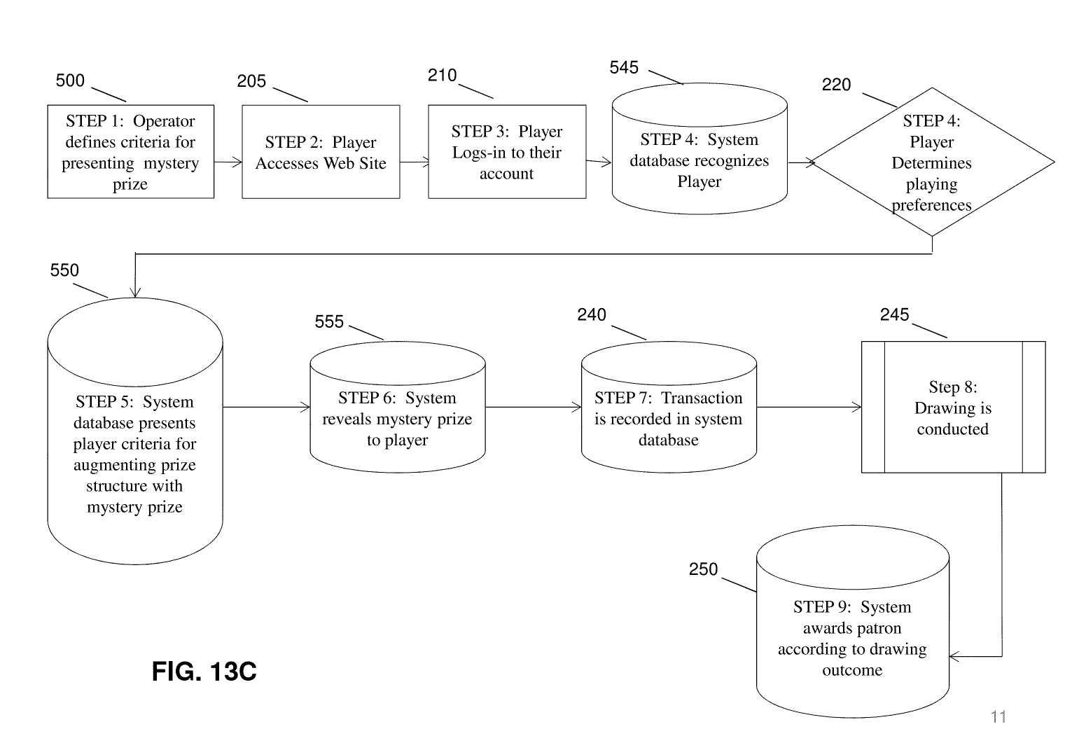

The personal play system may additionally employ a mystery prize feature for selectively offering a mystery prize to a player based on the player's activity or random chance. As described in detail below, the player may also be offered the mystery prize as part of an up-sell offer. The flowcharts in FIGS. 13A-13C illustrate this feature. The offer may include, but is not limited to, an adjustment to the standard prize structure. For example, the player may place a $1.00 straight wager for a Pick 3 drawing. The traditional prize structure provides that the player will win $500 if they match all three digits, the odds of which are 1:1000. The lottery system may selectively offer a mystery prize to the player to augment the prize structure, providing the player the opportunity to win an additional prize in excess of the traditional prize amount. For example, an adjustment may include merchandise, an experiential prize, a monetary prize, or some combination thereof, either in place or in addition to the prizes offered in the standard prize structure. For example, the mystery prize may be a car in addition to the $500 winning amount. Generally, the lottery system generally presents the actual prize to the player prior to the lottery drawing, e.g., a car. However, it is within the scope of the present invention for the lottery system to withhold the nature of the prize from the player until during or after the lottery drawing, based on the criteria defined by a lottery system operator.

Similar to the features described above, an operator defines the criteria for presenting one or more mystery prize to players 500. When the criteria for presenting the mystery prize indicates random chance, the flowchart in FIG. 13A generally illustrates this process. The player again accesses the web site 205 and logs into their account 210. The web interface then prompts the player to select their playing preferences 220. The personal play system recognizes the player's selected playing preferences as meeting the mystery prize criteria 305, displays the mystery prize to the player 510 and, at 240, records the transaction in the database 16. A lottery drawing is conducted 245 and the personal play system awards the player according to the drawing outcome 250.

When the criteria for presenting the mystery prize indicates player characteristics, the flowchart in FIG. 13B generally illustrates this process. Similar to the process shown in FIG. 13A, the player accesses the web site 205 and logs into their account 210. The personal play system recognizes the player as meeting the defined mystery prize criteria 505 and the web interface prompts the player to select their playing preferences 220. The system then recognizes the play criteria as meeting the defined mystery prize criteria 505. The play criteria may include, but is not limited to, player characteristics stored in the system database and the playing preferences selected by the player. Based on the recognized play criteria, the personal play system displays the mystery prize to the player 510 via the web interface and, at 240, records the transaction in the database 16. A lottery drawing is conducted 245 and the personal play system awards the player according to the drawing outcome 250.

When the criteria for presenting the mystery prize indicates an up-sell offer, the flowchart in FIG. 13C generally illustrates this process. Similar to the process shown in FIGS. 13A and 13B, the player accesses the web site 205 and logs into their account 210. Once the personal play system recognizes the player 545, the web interface prompts the player to select their playing preferences 220. The system then determines that the player and his selected preferences match the determined player criteria for augmenting the prize structure with a mystery prize 550, displays the mystery prize to the player 510 for player selection and, at 240, records the transaction in the database 16. A lottery drawing is conducted 245 and the personal play system awards the player according to the drawing outcome 250.

It will be appreciated that the recorded transaction information may be used to display messages via a website, a social media network, etc. The host computer 12 or another computer/computerized service may utilize the recorded transaction information in the database 16 to determine which players have selected the mystery prize option for an upcoming drawing and then generate appropriate messages for display. By way of example and not limitation, the message may indicate “John Doe has an opportunity to win a car during tonight's Pick 3 drawing”

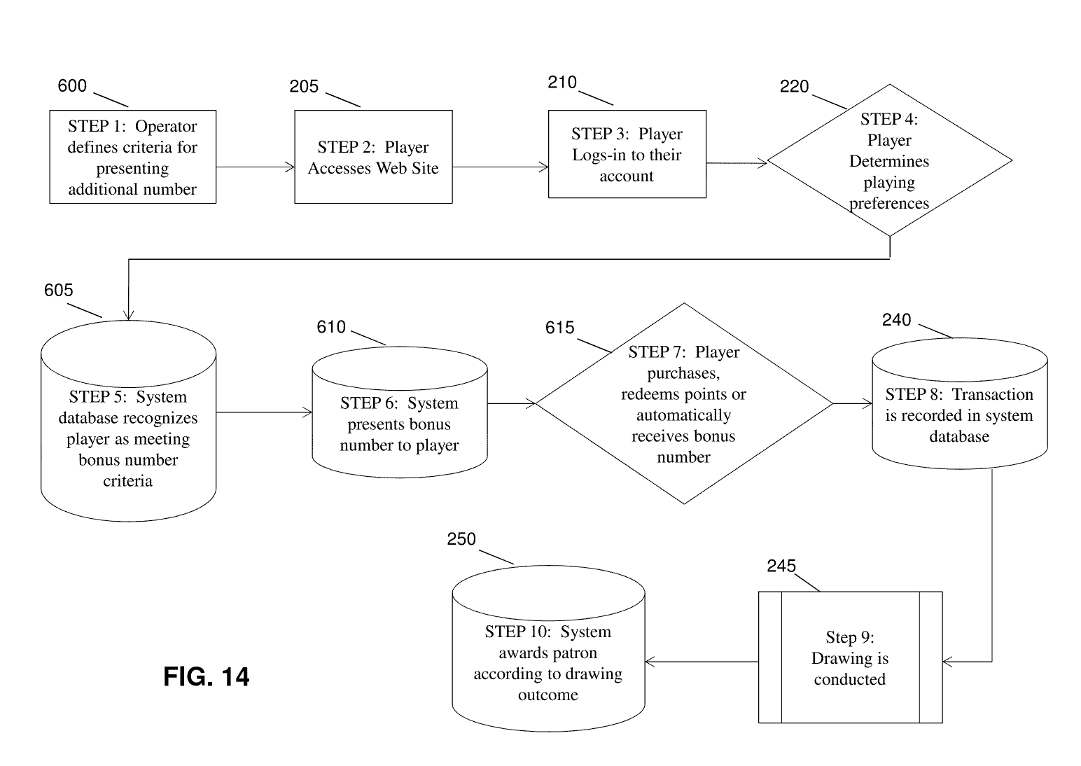

The personal play system may also employ a bonus number feature for selectively offering a bonus number based on the player activity, player characteristics, random chance, or some combination thereof. For example, the system may offer a player with six numbers in a Lotto lottery to select a seventh number. When a lottery drawing is held, six of the seven numbers must match the drawn numbers in order for the player to win. In a Lotto lottery, the order of numbers selected is immaterial. The flowchart in FIG. 14 illustrates this feature. Similar to the featured described above, an operator defines the criteria for presenting one or more mystery prize to players 600. The player accesses the web site 205 and logs into their account 210. The personal play system prompts the player to select their playing preferences 220 via the web interface and then determines that the player and his selected preferences match the determined bonus number criteria 605. The system thereafter presents the bonus number to the player 610. The personal play system may be configured to generate the bonus number for the play, to permit the player to provide their own number, or both. In some instances, such as Numbers games where the order of numbers selected matter, e.g., Pick 3, the system may be configured to assign a bonus number position, prompt the player to select a bonus number position, or both. The bonus number position indicates to which number the bonus number applies, e.g., in a Pick 3 game, “1 or 5”-2-3.

The player then purchases, redeems points, or automatically receives the bonus number 615, based on the defined criteria for presenting the additional number, player characteristics, other configuration settings of the system, or some combination thereof. At 240, the personal play system records the transaction in the database 16. A lottery drawing is conducted 245 and the personal play system awards the player according to the drawing outcome 250.

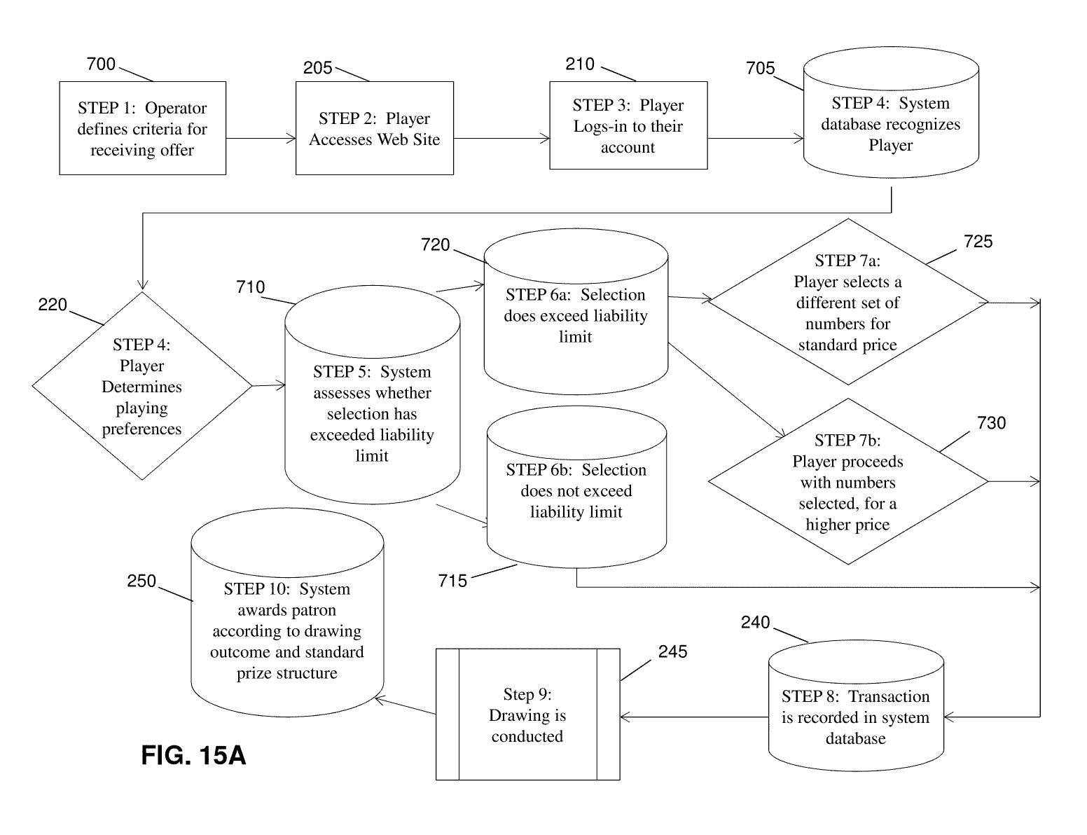

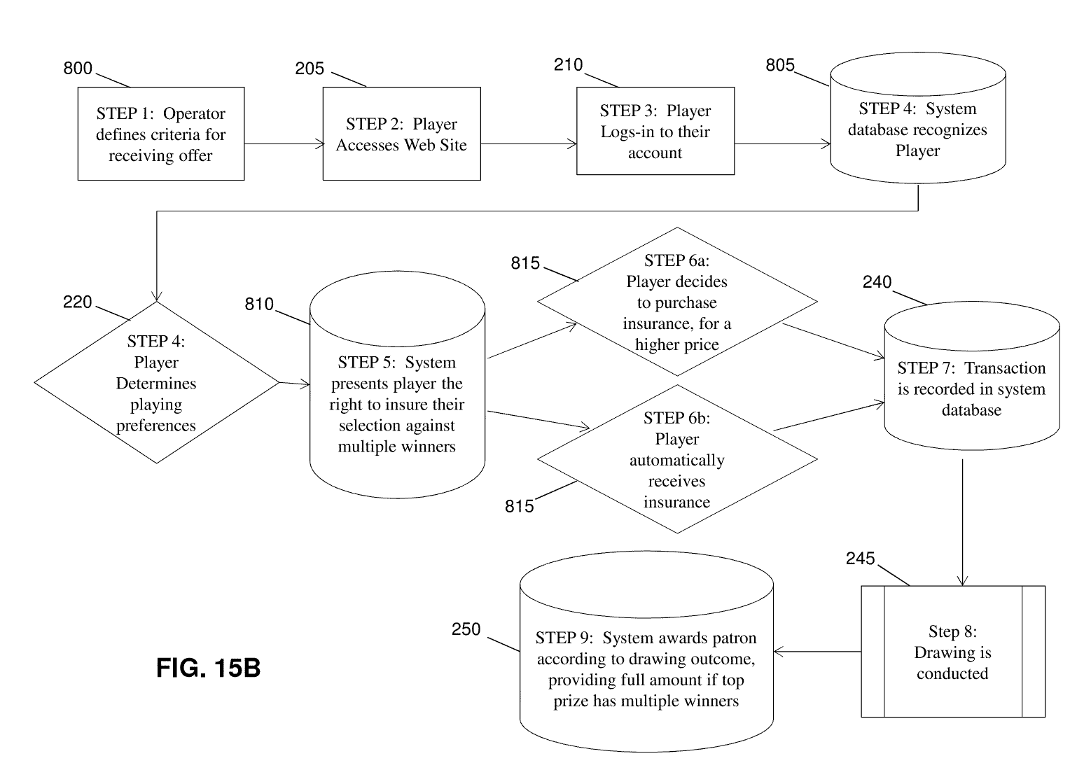

The personal play system may also employ a SurePlay feature that permits a player to select a game and indicate the player's preferred numbers for the game. The flowcharts in FIGS. 15A and 15B illustrate this feature. In the case of fixed-odds games, such as Pick 3 (odds of 1:1000) or Pick 4 (odds of 1:10,000), the flowchart in FIG. 15A generally illustrates this process. Fixed-odds games are those games where participation by other players does not impact the prize structure, e.g., matching all three numbers in a Pick 3 game pays the player $500, regardless of how many other players successfully matched the numbers. Similar to the features described above, an operator defines the criteria for presenting the SurePlay feature to players 700. The player again accesses the web site 205 and logs into their account 210. Once the personal play system recognizes the player 705, the web interface prompts the player to select their playing preferences 220, including, but not limited to, the player's preferred numbers.

The system then assesses whether the player's preferred numbers exceeded an established liability limit for the player's selected game 710. If the system determines that the preferred numbers do not exceed the liability limit 715, the personal play system records, at 240, the transaction in the system database 16. If the system determines that the preferred numbers do exceed the established liability limit for the player selected game 720, the system prompts the player, via the web interface, to either select a different set of preferred numbers for the game's standard price 725 or proceed with the preferred numbers for a price higher than the game's standard price 730. This higher price permits the lottery operator to offset the marginal increase in liability that the preferred numbers represent. In some instances, however, the system may permit the player to proceed with the preferred numbers at the game's standard price, such as when the player's historical play (loyalty tier) meets or exceeds a particular threshold. The system then, at 240, records the transaction in the system database 16. A lottery drawing is conducted 245 and the personal play system awards the player according to the drawing outcome 250.

The flowchart in FIG. 15B generally illustrates the SurePlay feature process for pari-mutuel games. In a pari-mutuel game, a winning player shares the prize with any other winning players. For example, if a Lotto game has a jackpot of $100,000, four players with the same winning numbers will each receive $25,000, or ¼ of the $100,000 jackpot. The SurePlay feature permits a player to “insure” his number selection against multiple winners, e.g., the player wins the $100, rather than $25. Similar to the fixed-odds game example above, an operator defines the criteria for presenting the SurePlay feature to players 800. The player again accesses the web site 205 and logs into their account 210. Once the personal play system recognizes the player 805, the web interface prompts the player to select their playing preferences 220, including, but not limited to, the player's preferred numbers. The system then selectively presents the player an option to insure their preferred numbers against multiple winners 810. The player then either elects to purchase insurance for an additional amount 815 or the player automatically receives the insurance 820. The personal play system selectively presents and/or automatically applies the insurance based on the defined criteria for presenting the SurePlay offer, player characteristics, other configuration settings of the system, or some combination thereof. At 240, the system records the transaction in the system database 16. A lottery drawing is conducted 245 and the personal play system awards the player according to the drawing outcome 250.

With respect to the SurePlay feature process in FIG. 15B, the personal play system may also selectively use the suggestive-sell feature described above to offer the player unused number combinations at a premium, such that a winning player would not share the same numbers with other players. This suggestive-sell offer may occur at 220, 710, or any other suitable part of the process. Additionally, the suggestive-sell offer may present multiple unused combinations as a “bundle” at a premium or discounted price, as determined by the lottery operator.

An added benefit of a player utilizing the present invention (or a similar mechanism for identifying the player) is the ability to provide notices to that player. For example, as an option in the player's account, the player could be asked to provide an email address or mobile number so that the player can be notified when their identified play is determined to be a winner.

For a player utilizing the present invention (or similar mechanism for identifying the player), winning outcomes could be automatically applied to a player's bank account. As an option in the player's account, the player could specify a bank account that any winnings will be deposited in. In addition to directing winnings to a bank account, other parameters in a player's account could be configurable. It is possible that certain winning outcomes might have conditions applied to them. For instance, a configuration might specify that any winnings less than $3 be directed to an entity (i.e. charitable organization) on behalf of the player.

For players that do not have access to the internet, adding a player identification field 62 to the game playing field 64 on existing play-slips 66 provides the player a way to distinguish their ticket. For example, as shown in FIG. 9 with reference to a current Lotto ticket, four columns from 0-9 for identification purposes can be used on a play-slip. This is just one example of how this could be implemented. For example, any alpha-numeric character options could be used in the payer ID field. It will be appreciated that this field can take whatever form is necessary to fit within the available space on a particular play-slip. The important point to note is that the code provides a simple method of identifying the ticket and eventually the validation receipt, providing the player assurance that their ticket was processed appropriately. Since this method doesn't utilize the web interface, specifying the personal data that will be displayed is not an option. However, the code selected by the player will be displayed on both the ticket and the validation receipt.

Given the various communications options, it will be appreciated that any currently known communication system between computer systems and other communications devices can be used, including without limitation telephony, cable, fiber optic, cellular, satellite and any other wired or wireless communication system. Embodiments of the host computer 12 may include a general purpose computing device having one or more processors or processing units and an internal memory area. As known to those skilled in the art, the general purpose computing device may further include a system bus coupled to additional system components, such as peripheral component interfaces, and at least some form of computer readable storage media, which include both volatile and nonvolatile media, removable and non-removable media. By way of example, and not limitation, such computer-readable storage media can comprise read-only memory (ROM), random-access memory (RAM), electronically-erasable programmable read-only memory (EEPROM), DVD-ROM, CD-ROM or other optical disk storage, magnetic disk storage, magnetic tape storage, or other magnetic storage devices, or any other medium that can be used to store desired program code means in the form of data structures or computer-executable instructions which can be accessed by a general purpose or special purpose computer. Computer-executable instructions comprise, for example, instructions and data which cause a general purpose computer, special purpose computer, or special purpose processing device to perform a certain function or group of functions.

Also, the host system 12 and/or computer communication network 24 may include communication media, which typically embody computer readable instructions, data structures, program modules, or other data in a modulated data signal such as a carrier wave or other transport mechanism and include any information delivery media. Those skilled in the art are familiar with the modulated data signal, whereby one or more of its characteristics are set, altered or otherwise changed in order to encode information in the signal. Wired media, such as a wired network or direct-wired connection, and wireless media, such as infrared, RF and other wireless media, are examples of communication media. Combinations of any of the above are also included within the scope of computer readable media.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method for providing personalized plays in a host lottery system in operative communication with a plurality of electronic scanners at corresponding retailer terminals, comprising the steps of:
maintaining an electronic database of player accounts, game options and play criteria options securely accessible through a computer network, wherein said player accounts comprise player identifiable information, and wherein said game options and said play criteria options are defined according to the host lottery system;
presenting said game options and said play criteria options to an authorized player through said computer network;
selectively presenting to said authorized player one or more alternative prize structures based on at least one of said player identifiable information, said presented game options, and said play criteria options, wherein said alternative prize structures are comprised of a plurality of optional prize structures, wherein said authorized player selects one of said optional prize structures for a selected game, said alternative prize structures are comprised of one or more sets of payouts for corresponding numbers of lottery matches;
receiving play data from said authorized player through said computer network, wherein said play data comprises a selection of said presented game options, corresponding play criteria options, and alternative prize options for said authorized player;
creating a personalized game document with unique data comprising said player identifiable information and said play data for said authorized player, wherein said unique data is formatted in a scanning-code recognizable to the electronic scanners at the retailer terminals; and
transmitting an electronic version of said personalized game document to said authorized player through said computer network.

2. The method of claim 1, further comprising the step of instructing said authorized player to present said personalized game document to a participating retailer for processing said unique data with the host lottery system.

3. The method of claim 2, further comprising the steps of:
instructing said participating retailer to scan said personalized game document using the electronic scanners and to provide said authorized player with a personalized lottery ticket corresponding with said unique data on said personalized game document as interpreted by the host lottery system;
sending said player identifiable information and said play data for said authorized player to the host lottery system from the retailer terminal at said participating retailer;
logging said player identifiable information and said play data for said authorized player at the host lottery system as a recorded transaction; and
sending a verification report to the retailer terminal of said participating retailer to authorize printing of a personalized lottery ticket for said recorded transaction, wherein said personalized lottery ticket comprises said player identifiable information and said play data corresponding with said unique data on said personalized game document.

4. The method of claim 1, wherein said alternative prize structures are based on said play data in combination with at least one of said player identifiable information, said presented game options and said play criteria options.

5. The method of claim 1, wherein said alternative prize structures are comprised of at least one standard prize and at least one additional non-standard prize.

6. The method of claim 5, wherein said non-standard prize is selected from at least one of a single price point prize and a multiple price point prize.

7. The method of claim 1, further comprising the steps of:
receiving at said host lottery system information corresponding to a winning personalized lottery ticket;
authorizing said participating retailer to pay a winning amount with a validation receipt confirming said player identifiable information; and
providing software code to at least one of the host lottery system and the retailer terminals for interpreting said scanning-code of said unique data, wherein said software code resolves said scanning-code into said player identifiable information and said play data.

8. The method of claim 1, further comprising the step of providing at least one of a mobile phone application and a webpage interface for a plurality of players to securely access respective player accounts on said maintained electronic database.

9. The method of claim 1, wherein selectively providing alternative prize structure options includes an up-sell offer associated with one or more of said alternative prize structures, said up-sell offer having a cost associated therewith, said up-sell offer comprising a mystery prize, a monetary prize, a merchandise prize, a drawing entry, loyalty points, or some combination thereof.

10. The method of claim 1, wherein selectively providing alternative prize structure options includes a suggestive sell offer associated with one or more of said alternative prize structures, said suggestive sell offer indicating one or more play combinations for player selection, each combination having a cost associated therewith.

11. The method of claim 1, wherein selectively providing alternative prize structure options includes a mystery prize offer associated with one or more of said alternative prize structures.

12. The method of claim 1, wherein selectively providing alternative prize structure options includes a bonus number offer associated with one or more of said alternative prize structures said bonus number offer comprising an number for one or more of said game options, wherein said bonus number is selected by said authorized player.

13. The method of claim 1, wherein selectively providing alternative prize structure options includes a pari-mutuel SurePlay offer associated with one or more of said alternative prize structures, wherein said SurePlay provides said authorized player an option for insuring a win would not be shared with any other winning players.

14. The method of claim 1, wherein selectively providing alternative prize structure options includes a fixed-odds SurePlay offer associated with one or more of said alternative prize structures, wherein said SurePlay offer provides said authorized player an option to purchase a number selection that would otherwise be restricted by the host lottery system, said SurePlay offer having an associated cost.

15. A method for providing personalized plays in a host lottery system in operative communication with a plurality of electronic scanners at corresponding retailer terminals, comprising the steps of:
maintaining an electronic database of player accounts, game options and play criteria options securely accessible through a computer network, wherein said player accounts comprise player identifiable information, and wherein said game options and said play criteria options are defined according to the host lottery system;
presenting said game options and said play criteria options to an authorized player through said computer network;
providing alternative prize structures in said play criteria options, wherein said alternative prize structures are comprised of a plurality of optional prize structures selectable by a plurality of authorized players, said optional prize structures comprising comprises a standard prize and at least one additional non-standard prize, wherein said authorized players can select between said standard prize and said non-standard prize, said alternative prize structures further comprised of sets of varying payouts for corresponding numbers of lottery matches;
receiving play data from said authorized player through said computer network, wherein said play data comprises a selection of said presented game options, corresponding play criteria options, and alternative prize options for said authorized player;
creating a personalized game document with unique data comprising said player identifiable information and said play data for said authorized player, wherein said unique data is formatted in a scanning-code recognizable to the electronic scanners at the retailer terminals; and
transmitting an electronic version of said personalized game document to said authorized player through said computer network.

16. The method of claim 15, wherein said alternative prize structures are selected from the group of prizes consisting of a plurality of single price point game prizes and a plurality of multiple price point game prizes.

17. A system for providing lottery personalized plays, said system comprising:
a lottery information database for maintaining an electronic database of player accounts, game options and play criteria options securely accessible through a computer network, wherein said player accounts comprise player identifiable information, and wherein said game options and said play criteria options are defined according to the host lottery system;
a lottery system host computer, said host computer being in operative communication with the lottery information data, said host computer including one or more computer-readable storage media having stored thereon computer-executable instructions for:
presenting said game options and said play criteria options to an authorized player through said computer network;
providing alternative prize structures in said play criteria options, wherein said alternative prize structures are comprised of a plurality of optional prize structures selectable by a plurality of authorized players, said optional prize structures comprising comprises a standard prize and at least one additional non-standard prize, wherein said authorized players can select between said standard prize and said non-standard prize;
receiving play data from said authorized player through said computer network, wherein said play data comprises a selection of said presented game options, corresponding play criteria options, and alternative prize options for said authorized player;
creating a personalized game document with unique data comprising said player identifiable information and said play data for said authorized player, wherein said unique data is formatted in a scanning-code recognizable to the electronic scanners at the retailer terminals; and
transmitting an electronic version of said personalized game document to said authorized player through said computer network.

18. The system of claim 17, wherein said alternative prize structures are selected from the group of prizes consisting of a plurality of single price point game prizes and a plurality of multiple price point game prizes.

19. The system of claim 17, wherein said alternative prize structures are based on said play data in combination with the at least one of said player identifiable information, said presented game options and said play criteria options.

20. The system of claim 17, wherein each one of said alternative prize structures comprises a plurality of price points, wherein said alternative prize structures are further comprised of sets of varying payouts for corresponding numbers of lottery matches.
